(19) United States
(12) Patent Application Publication
(10) Pub. No.: US 2026/0281719 A1
(43) Pub. Date: Sep. 17, 2026

(54) MANAGEMENT OF AKMA SERVICES TO USER EQUIPMENT

(71) Applicant: Nokia Technologies Oy, Espoo (FI)

(72) Inventors: Saurabh KHARE, Bangalore (IN); Rajesh Babu NATARAJAN, Bangalore (IN); Ranganathan MAVUREDDI DHANASEKARAN, Munich (DE)

(21) Appl. No.: 19/472,992

(22) PCT Filed: Apr. 2, 2024
(86) PCT No.: PCT/IB2024/053199

§ 371 Date: Oct. 6, 2025

(30) Foreign Application Priority Data
Apr. 10, 2023 (IN) 202311026509

(51) Int. Cl. H04W 12/041; H04W 12/0431; H04W 12/06; H04W 84/04

(52) U.S. Cl. CPC H04W 12/041; H04W 12/0431; H04W 12/06; H04W 84/042

(57) ABSTRACT

Systems and methods of performing an Authentication and Key Management for Applications (AKMA) service. In one embodiment, a method comprises determining, during primary authentication of user equipment (UE), whether a serving network of the UE belongs to a home public land mobile network. Responsive to determining that the serving network belongs to the home public land mobile network, the method comprises determining that an AKMA service is enabled for a registration of the UE with the serving network, and performing derivation of an AKMA anchor key. Responsive to determining that the serving network does not belong to the home public land mobile network, the method comprises determining that the AKMA service is disabled. After the primary authentication is successful, the method comprises providing an AKMA service indicator from the home public land mobile network to the UE that indicates whether the AKMA service is enabled or disabled.

### TECHNICAL FIELD

This disclosure is related to the field of communication systems and, in particular, to next generation networks.

### BACKGROUND

Next generation networks, such as Fifth Generation (5G), denote the next major phase of mobile telecommunications standards beyond Fourth Generation (4G) standards. In comparison to 4G networks, next generation networks may be enhanced in terms of radio access and network architecture. Next generation networks intend to utilize new regions of the radio spectrum for Radio Access Networks (RANs), such as millimeter wave bands.

With mobile networks widely used across the country and the world, communications may be intercepted or suffer from other kinds of attacks. To ensure security and privacy, the 3rd Generation Partnership Project (3GPP) has set forth security mechanisms for 5G mobile networks, and the security procedures performed within the 5G mobile networks. One of the security procedures between User Equipment (UE) and a 5G mobile network is primary authentication and key agreement. Primary authentication and key agreement procedures enable mutual authentication between the UE and the network, and provide keying material that can be used between the UE and the serving network in subsequent security procedures. After primary authentication, a Non-Access Stratum (NAS) security context and an Access Stratum (AS) security context are created for the UE.

Another security procedure is between UEs and application providers, and is referred to as Authentication and Key Management for Application (AKMA). AKMA is a feature that leverages an operator authentication infrastructure to secure communications between a UE and an Application Function (AF). AKMA is described in 3GPP TS 33.535(v 17.7.0 ), which is incorporated by reference as if fully included herein. AKMA reuses the 5G primary authentication procedure to authenticate a UE.

Presently, roaming aspects are not considered in present 3GPP standards for AKMA.

### SUMMARY

Described herein are enhanced AKMA procedures that address roaming of UEs, considering access types of UEs and/or other factors. In general, a UE may have service availability when connected to a home Public Land Mobile Network (HPLMN) through one or more access types, such as 3GPP access and non-3GPP access (trusted or untrusted). A UE may have service availability when connected to a visited Public Land Mobile Network (VPLMN) through one or more access types (again, such as 3GPP access and non-3GPP access (trusted or untrusted)). In embodiments described herein, the HPLMN of a UE determines whether an AKMA service is enabled or disabled based at least in part on the serving network through which the UE attempts to register or is registered. For example, if a UE is connected to the HPLMN via 3GPP access or non-3GPP access, then an AKMA service is enabled. If a UE is connected to a VPLMN via 3GPP access or non-3GPP access, then an AKMA service may be disabled. Thus, the HPLMN can limit UE access to AKMA services from a VPLMN. One technical benefit is, although a UE may support an AKMA service, the AKMA service may be selectively enabled or disabled by the HPLMN for individual registrations of the UE with a serving network. For example, an AKMA service may be allowed for an application session of a UE that is roaming and connected to the HPLMN via non-3GPP access, but denied to the UE that is roaming and connected to the VPLMN via 3GPP access.

In one embodiment, a method of performing an AKMA procedure is disclosed. The method comprises determining, during primary authentication of user equipment, whether a serving network of the user equipment belongs to a home public land mobile network of the user equipment. Responsive to determining that the serving network belongs to the home public land mobile network, determining, in the home public land mobile network, that an AKMA service is enabled for a registration of the user equipment with the serving network, and performing, in the home public land mobile network, derivation of an AKMA anchor key. Responsive to determining that the serving network does not belong to the home public land mobile network, determining, in the home public land mobile network, that the AKMA service is disabled for the registration of the user equipment with the serving network. The method further comprises providing, after the primary authentication is successful, an AKMA service indicator from the home public land mobile network to the user equipment, where the AKMA service indicator indicates whether the AKMA service is enabled or disabled for the registration of the user equipment with the serving network.

In one embodiment, a 5G system comprises a home public land mobile network of user equipment that supports AKMA. The home public land mobile network comprises at least one processor, and at least one memory storing instructions that, when executed by the at least one processor, cause the home public land mobile network at least to determine, during primary authentication of the user equipment, whether a serving network of the user equipment belongs to the home public land mobile network. Responsive to a determination that the serving network belongs to the home public land mobile network, the at least one processor causes the home public land mobile network at least to determine that an AKMA service is enabled for a registration of the user equipment with the serving network, and perform derivation of an AKMA anchor key. Responsive to a determination that the serving network does not belong to the home public land mobile network, the at least one processor causes the home public land mobile network at least to determine that the AKMA service is disabled for the registration of the user equipment with the serving network. The at least one processor causes the home public land mobile network at least to provide, after the primary authentication is successful, an AKMA service indicator to the user equipment, where the AKMA service indicator indicates whether the AKMA service is enabled or disabled for the registration of the user equipment with the serving network.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a high-level architecture of a 5G system.

FIG. 2 illustrates a non-roaming architecture of a 5G system.

FIG. 3 is a signaling diagram that illustrates initiation of primary authentication.

FIG. 4 is a signaling diagram that illustrates an authentication procedure.

FIG. 5 illustrates a fundamental network model for AKMA.

FIG. 6 illustrates an AKMA architecture in reference point representation for internal AFs.

FIG. 7 illustrates an AKMA architecture in reference point representation for external AFs.

FIG. 8 is a signaling diagram that illustrates generating of the AKMA Anchor Key (K_{AKMA}) after primary authentication.

FIG. 9 is a signaling diagram that illustrates generating of the AKMA Application Key (K_{AF}).

FIG. 10 illustrates non-roaming and roaming scenarios for a UE.

FIGS. 11A-11B illustrate non-roaming architectures.

FIGS. 11C-11D illustrate roaming architectures.

FIG. 12 is a flow chart illustrating a method of performing an AKMA procedure in an illustrative embodiment.

FIG. 13 is a block diagram of a UDM in an illustrative embodiment.

FIG. 14 is a block diagram of an AAnF in an illustrative embodiment.

FIG. 15 is a block diagram of a UE in an illustrative embodiment.

FIGS. 16A-16B are message diagrams illustrating an AKMA procedure in an illustrative embodiment.

FIG. 17 is a flow chart illustrating a method of managing an AKMA service in an illustrative embodiment.

FIG. 18 is a flow chart illustrating a method of updating an AKMA context in an illustrative embodiment.

FIG. 19 is a message diagram illustrating an update to an AKMA context in an illustrative embodiment.

FIG. 20 is a flow chart illustrating a method of updating an AKMA context in an illustrative embodiment.

FIG. 21 is a message diagram illustrating a UPU procedure to provide an AKMA service indicator to a UE in an illustrative embodiment.

FIG. 22 is a message diagram illustrating a UE configuration update procedure to provide an AKMA service indicator to a UE in an illustrative embodiment.

FIG. 23 is a flow chart illustrating a method of updating a UE in an illustrative embodiment.

FIGS. 24A-24B are signaling diagrams illustrating key generation for an AKMA service in an illustrative embodiment.

FIG. 25 is a flow chart illustrating a method of managing key generation at an AF in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

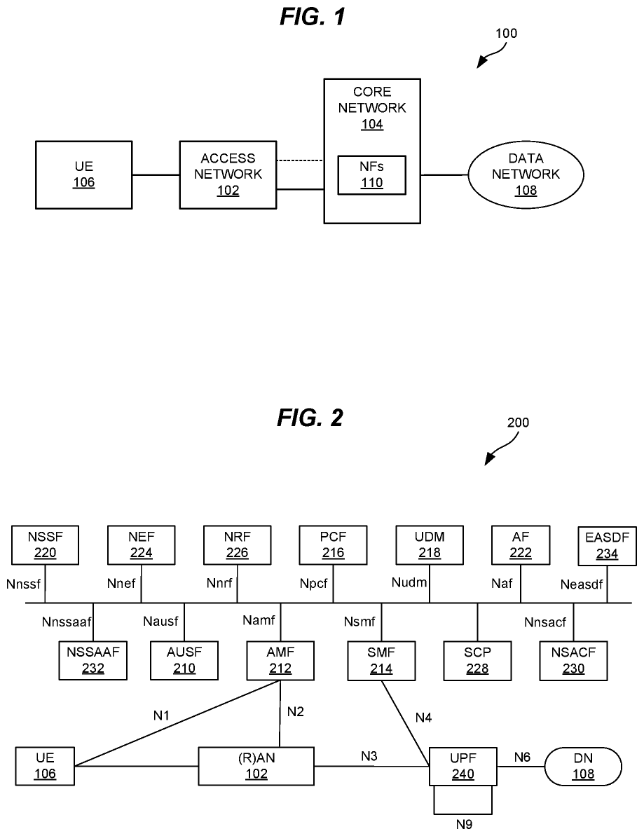

FIG. 1 illustrates a high-level architecture of a 5G system 100. A 5G system (5GS) 100 is a communication system (e.g., a 3GPP system) comprising a 5G Access Network ((R)AN) 102 and a 5G core network (5GC) 104 that communicates with 5G User Equipment (UE) 106. Access network 102 provides radio or wireless connectivity to UE 106, and connects UE 106 to 5GC 104. Access network 102 may comprise a Next Generation Radio Access Network (NG-RAN), a non-3GPP access network, or another type of RAN connecting to 5GC 104. Access network 102 may support Evolved-UMTS Terrestrial Radio Access Network (E-UTRAN) access (e.g., through an eNodeB, gNodeB, and/or ng-eNodeB), Wireless Local Area Network (WLAN) access, fixed access, satellite radio access, new Radio Access Technologies (RAT), etc. 5GC 104 interconnects access network 102 with a data network (DN) 108. 5GC 104 is comprised of Network Functions (NF) 110, which may be implemented either as a network element on dedicated hardware, as a software instance running on dedicated hardware, as a virtualized function instantiated on an appropriate platform (e.g., a cloud infrastructure), etc. Data network 108 may be an operator external public or private data network, or an intra-operator data network (e.g., for IMS services). UE 106 (also referred to as a mobile terminal) is a 5G capable device configured to register with 5GC 104 to access services. UE 106 may be an end user device, such as a mobile phone (e.g., smartphone), a tablet, a computer with a mobile broadband adapter, etc. UE 106 may be enabled for voice services, data services, Machine-to-Machine (M2M) or Machine Type Communications (MTC) services, and/or other services.

FIG. 2 illustrates a non-roaming architecture 200 of a 5G system. The architecture 200 in FIG. 2 is a service-based representation, as is further described in 3GPP TS 23.501(v18.0.0 ), which is incorporated by reference as if fully included herein. Architecture 200 is comprised of Network Functions (NF) for a 5GC 104, and the NFs for the control plane (CP) are separated from the user plane (UP). The control plane of the 5GC 104 includes an Authentication Server Function (AUSF) 210, an Access and Mobility Management Function (AMF) 212, a Session Management Function (SMF) 214, a Policy Control Function (PCF) 216, a Unified Data Management (UDM) 218, a Network Slice Selection Function (NSSF) 220, and an Application Function (AF) 222. The control plane of the 5GC 104 further includes a Network Exposure Function (NEF) 224, a NF Repository Function (NRF) 226, a Service Communication Proxy (SCP) 228, a Network Slice Admission Control Function (NSACF) 230, a Network Slice-specific and SNPN Authentication and Authorization Function (NSSAAF) 232, and an Edge Application Server Discovery Function (EASDF) 234. The user plane of the 5GC 104 includes one or more User Plane Functions (UPF) 240 that communicate with data network 108. UE 106 is able to access the control plane and the user plane of the core network 104 through (R)AN 102.

There are a large number of subscribers that are able to access services from a carrier or home network operator that implements a mobile network comprising a 5G system 100, such as in FIGS. 1-2. Communications between the subscribers (i.e., through a UE) and the mobile network are protected by security mechanisms, such as the ones standardized by the 3GPP. Subscribers and the carrier expect security guarantees from the security mechanisms. One of the security mechanisms is the primary authentication procedure that provides mutual authentication between the UE and the network. The following further illustrates primary authentication.

The purpose of the primary authentication and key agreement procedures is to enable mutual authentication between UE 106 and the home network of the UE 106, and provide keying material that can be used between the UE 106 and the serving network in subsequent security procedures. The home network (e.g., HPLMN) represents an operator network or carrier network through which a subscriber (e.g., UE 106) has a subscription for services. The serving network has radio access equipment able to communicate with UE 106 via radio signals. The keying material generated by the primary authentication and key agreement procedure results in an anchor key (called the K_{SEAF} key) provided by the AUSF 210 of the home network to the Security Anchor Function (SEAF) of the serving network. The SEAF provides authentication functionality via the AMF 212 in the serving network, and supports primary authentication using a Subscription Concealed Identifier (SUCI) that contains the concealed Subscription Permanent Identifier (SUPI). The SUPI is a globally unique 5G identifier allocated to each subscriber in the 5G system 100. The SUCI is composed a SUPI type, a Home Network Identifier (HN-ID) identifying the home network of the subscriber, a Routing Indicator (RID) that is assigned to the subscriber by the home network operator and provisioned in the Universal Subscriber Identity Module (USIM) of the UE, a Protection Scheme Identifier, a Home Network Public Key Identifier, and a Scheme Output. The anchor key (K_{SEAF}) is derived from an intermediate key called the K_{AUSF} key. The K_{AUSF} key is established between the UE 106 and the home network resulting from the primary authentication procedure.

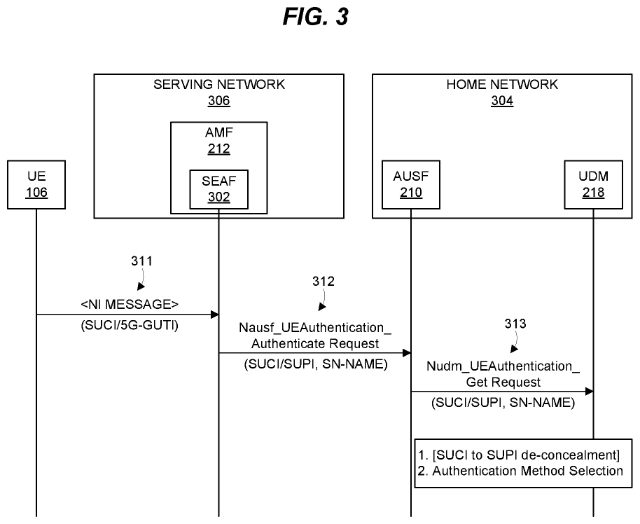

FIG. 3 is a signaling diagram that illustrates initiation of primary authentication, such as described in 3GPP TS 33.501(v18.0.0 ), which is incorporated by reference as if fully included herein. UE 106 transmits an N1 message 311 (i.e., an initial Non-Access Stratum (NAS) message) to the serving network 306 (e.g., the AMF 212 of the serving network 306), such as a Registration Request. The serving network 306 may also be referred to as a serving PLMN, or VPLMN in a roaming scenario. UE 106 uses the SUCI or a 5G Global Unique Temporary Identifier (5G-GUTI) in the Registration Request. SEAF 302 of the AMF 212 may initiate an authentication with UE 106 during any procedure establishing a signaling connection with UE 106. SEAF 302 invokes the Nausf_UEAuthentication service toward the home network 304 (e.g., HPLMN) by sending a Nausf_UEAuthentication_Authenticate Request message 312 to AUSF 210 to initiate an authentication. The Nausf_UEAuthentication_Authenticate Request message 312 includes the SUCI or SUPI, and the serving network name (SN-Name). Upon receiving the Nausf_UEAuthentication_Authenticate Request message 312, AUSF 210 checks that the requesting SEAF 302 in the serving network 306 is entitled to use the serving network name in the Nausf_UEAuthentication_Authenticate Request message 312 by comparing the serving network name with the expected serving network name. When the serving network 306 is authorized to use the serving network name, AUSF 210 sends a Nudm_UEAuthentication_Get Request message 313 to UDM 218 of the home network. The Nudm_UEAuthentication_Get Request message 313 includes the SUCI or SUPI, and the serving network name. Upon reception of the Nudm_UEAuthentication_Get Request message 313, UDM 218 identifies the SUPI (if received), or invokes a Subscription Identifier De-concealing Function (SIDF) that de-conceals the SUPI from the SUCI (if received). UDM 218 (or an Authentication credential Repository and Processing Function (ARPF) of UDM 218) selects or chooses the authentication method for primary authentication based on the SUPI.

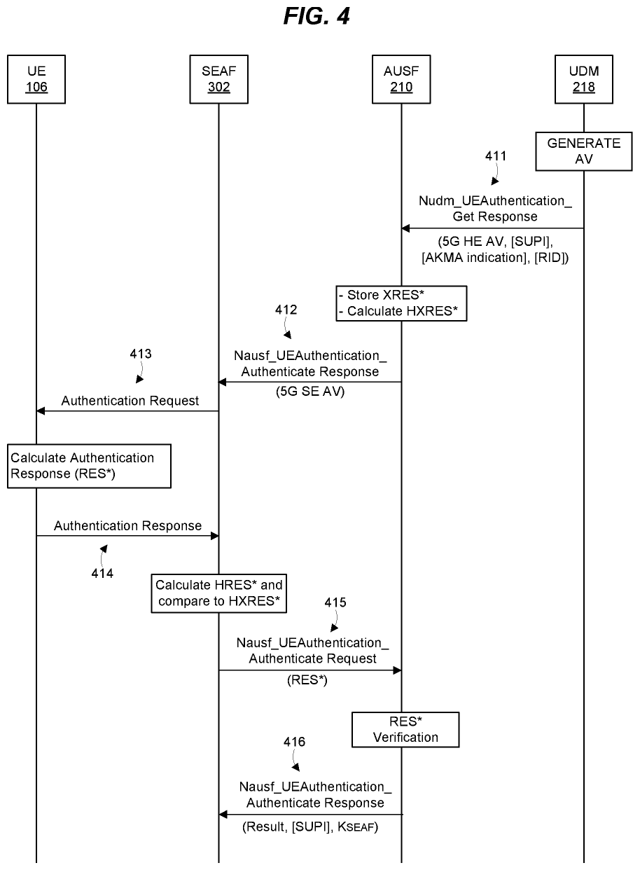

FIG. 4 is a signaling diagram that illustrates a primary authentication procedure, such as described in 3GPP TS 33.501. In this example, 5G Authentication and Key Agreement (AKA) is described, but similar concepts apply for Extensible Authentication Protocol AKA prime (EAP-AKA′). For a Nudm_UEAuthentication_Get Request, UDM 218 creates a 5G Home Environment Authentication Vector (5G HE AV) for the selected authentication method. UDM 218 derives the K_{AUSF} key and calculates an expected response (XRES*) to a challenge. UDM 218 creates the 5G HE AV comprising an authentication token (AUTN), the expected response (XRES*), the K_{AUSF} key, and a random challenge (RAND). UDM 218 then sends a Nudm_UEAuthentication_Get Response message 411 to AUSF 210 with the 5G HE AV to be used for authentication (e.g., 5G AKA in FIG. 4). In case the SUCI was included in the Nudm_UEAuthentication_Get Request, UDM 218 includes the SUPI in the Nudm_UEAuthentication_Get Response message 411 after de-concealment of the SUPI from the SUCI. If a subscriber has an Authentication and Key Management for Application (AKMA) subscription, UDM 218 may include an AKMA indication and the RID in the Nudm_UEAuthentication_Get Response message 411.

In response to the Nudm_UEAuthentication_Get Response message 411, AUSF 210 stores the expected response (XRES*) temporarily with the received SUCI or SUPI. AUSF 210 then generates a 5G Authentication Vector (5G AV) from the 5G HE AV received from UDM 218, by computing a hash expected response (HXRES*) from the expected response (XRES*) and the K_{SEAF} key from the K_{AUSF} key, and replacing the XRES* with the HXRES* and the K_{AUSF} key with the K_{SEAF} key in the 5G HE AV. AUSF 210 removes the K_{SEAF} key to generate a 5G Serving Environment Authentication Vector (5G SE AV) that includes the authentication token (AUTN), hash expected response (HXRES*), and the random challenge (RAND). AUSF 210 sends a Nausf_UEAuthentication_Authenticate Response message 412 to SEAF 302 that includes the 5G SE AV. In response, SEAF 302 sends the authentication token (AUTN) and the random challenge (RAND) to UE 106 in a NAS message Authentication Request message 413.

Although not shown in FIG. 4, UE 106 includes Mobile Equipment (ME) and a USIM. The ME receives the authentication token (AUTN) and the random challenge (RAND) in the NAS message Authentication Request message 413, and forwards the authentication token (AUTN) and the random challenge (RAND) to the USIM. The USIM of UE 106 verifies the freshness of the received values by checking whether the authentication token (AUTN) can be accepted. If so, the USIM computes a response (RES), a cipher key (CK), and an integrity key (IK) based on the random challenge (RAND), and returns the response (RES), the CK key, and the IK key to the ME. The ME of UE 106 computes RES* from RES, and calculates the K_{AUSF} key from CK∥IK and the K_{SEAF} key from the K_{AUSF} key.

UE 106 sends a NAS message Authentication Response message 414 to SEAF 302 that includes RES *. In response, SEAF 302 computes HRES* from RES*, and compares HRES* and HXRES*. If they coincide, SEAF 302 considers the authentication successful from the serving network point of view. SEAF 302 sends RES*, as received from UE 106, in a Nausf_UEAuthentication_Authenticate Request message 415 to AUSF 210. When AUSF 210 receives the Nausf_UEAuthentication_Authenticate Request message 415 including a RES* as authentication confirmation, AUSF 210 stores the K_{AUSF} key based on the home network operator's policy, and compares the received RES* with the stored XRES*. If the RES* and XRES* are equal, then AUSF 210 considers the authentication successful from the home network point of view. AUSF 210 informs UDM 218 about the authentication result (not shown). AUSF 210 also sends a Nausf_UEAuthentication_Authenticate Response message 416 to SEAF 302 indicating whether or not the authentication was successful from the home network point of view. If the authentication was successful, the K_{SEAF} key is sent to SEAF 302 in the Nausf_UEAuthentication_Authenticate Response message 416. In case AUSF 210 received the SUCI from SEAF 302 in the authentication request, AUSF 210 includes the SUPI in the Nausf_UEAuthentication_Authenticate Response message 416 if the authentication was successful.

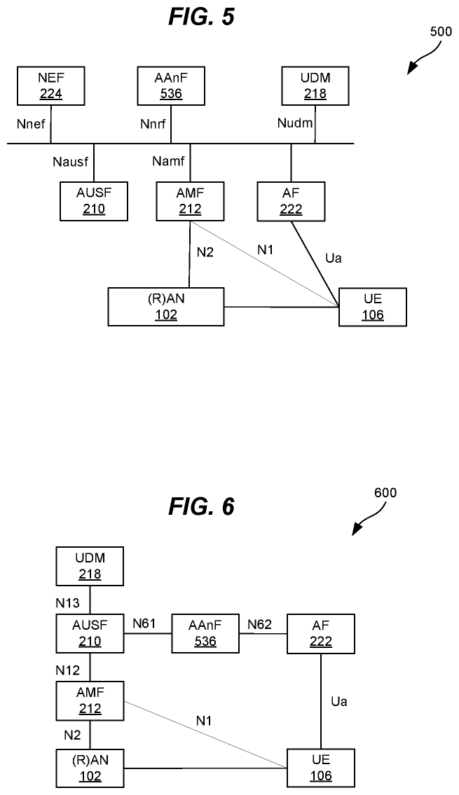

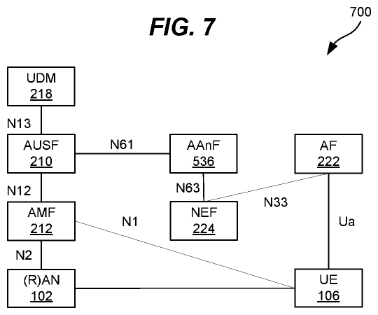

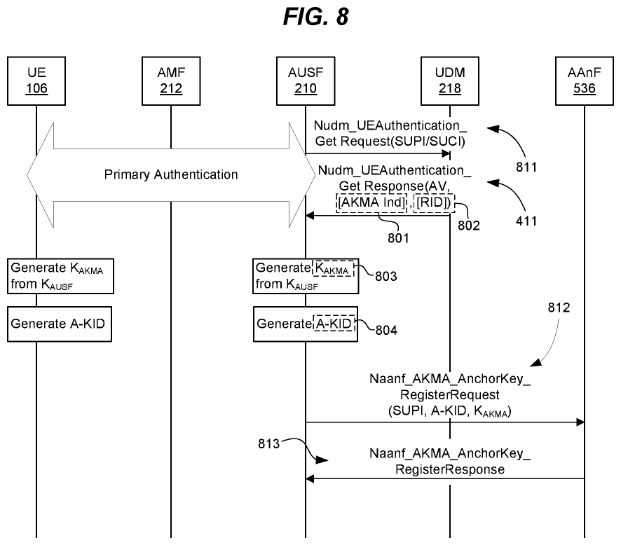

AKMA (Authentication and Key Management for Application) is a feature that leverages an operator authentication infrastructure to secure communications between a UE 106 and an AF 222, as described in 3GPP TS 33.535. FIG. 5 illustrates a fundamental network model 500 for AKMA. FIG. 6 illustrates an AKMA architecture 600 in reference point representation for internal AFs (i.e., AFs located inside the operator's network). FIG. 7 illustrates an AKMA architecture 700 in reference point representation for external AFs (i.e., AFs located outside the operator's network).

In FIG. 5, network model 500 for AKMA includes AUSF 210, AMF 212, UDM 218, AF 222, and NEF 224. Network model 500 for AKMA also includes an AKMA Anchor Function (AAnF) 536, which is the anchor function in the HPLMN. AAnF 536 stores the AKMA Anchor Key (K_{AKMA}) and the SUPI for the AKMA service, which is received from AUSF 210 after the UE 106 completes a successful 5G primary authentication. AAnF 536 also generates the key material to be used between the UE 106 and AF 222, and maintains UE AKMA contexts. AAnF 536 sends the SUPI of UE 106 to AF 222 located inside the operator's network, or to NEF 224. An AKMA AF 222 requests an AKMA Application Key, called K_{AF}, from AAnF 536 using an AKMA Key Identifier (A-KID).

AKMA reuses the 5G primary authentication procedure to authenticate a UE 106. As an overview, successful 5G primary authentication results in the K_{AUSF} key being stored at AUSF 210 and UE 106. After UE 106 finishes primary authentication and before it initiates communication with an AF 222, UE 106 generates the K_{AKMA} key and the A-KID from the K_{AUSF} key. After receiving the K_{AUSF} key from UDM 218, AUSF 210 stores the K_{AUSF} key, and generates the K_{AKMA} key and the A-KID from the K_{AUSF} key. AUSF 210 sends the K_{AKMA} key and the A-KID along with the SUPI of UE 106 to AAnF 536, which stores the K_{AKMA} key. Further details of an AKMA procedure are described below. FIG. 8 is a signaling diagram that illustrates generating of the AKMA Anchor Key (K_{AKMA}) after primary authentication. During the primary authentication procedure, AUSF 210 interacts with UDM 218 in order to fetch authentication information, such as subscription credentials (e.g., AKA Authentication vectors) and the authentication method using the Nudm_UEAuthentication_Get Request service operation (i.e., sending a Nudm_UEAuthentication_Get Request message 811 to UDM 218). In the response, UDM 218 may also provide an AKMA indication 801 to AUSF 210 whether the K_{AKMA} key 803 needs to be generated for UE 106 (i.e., if UE 106 supports AKMA). If the AKMA indication 801 is included, UDM 218 also includes the RID 802 of UE 106 in the Nudm_UEAuthentication_Get Response 411.

If AUSF 210 receives the AKMA indication 801 from UDM 218, AUSF 210 stores the K_{AUSF} key, and generates the K_{AKMA} key 803 and the A-KID 804 from the K_{AUSF} key after the primary authentication procedure is successfully completed. Likewise, UE 106 generates the K_{AKMA} key 803 and the A-KID 804 from the K_{AUSF} key before initiating communication with an AKMA AF 222. After the AKMA key material is generated, AUSF 210 selects the AAnF 536 and sends the A-KID 804 and the K_{AKMA} key 803 to AAnF 536 along with the SUPI of UE 106 using an Naanf_AKMA_AnchorKey_Register Request message 812. AAnF 536 sends a response to AUSF 210 using an Naanf_AKMA_AnchorKey_Register Response message 813.

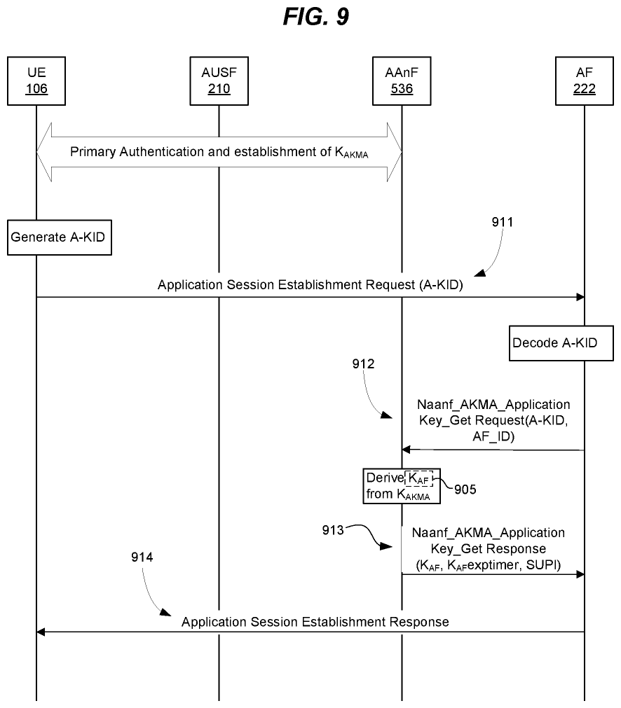

FIG. 9 is a signaling diagram that illustrates generating of the AKMA Application Key (K_{AF}). Before communication between UE 106 and the AKMA AF 222 can begin, UE 106 and the AKMA AF 222 need to know whether to use the AKMA service. This knowledge is implicit to the specific application on UE 106 and AKMA AF 222 or indicated by the AKMA AF 222 to UE 106. UE 106 generates the K_{AKMA} key 803 and the A-KID 804 from the K_{AUSF} key before initiating communication with an AKMA AF 222. When UE 106 initiates communication with the AKMA AF 222, UE 106 includes the A-KID 804 in a session request to the AKMA AF 222 (e.g., the Application Session Establishment Request message 911). UE 106 may derive the K_{AF} key before sending the session request or afterwards.

If the AKMA AF 222 does not have an active context associated with the A-KID 804, then the AKMA AF 222 selects an AAnF 536 based on the RID 802. The AKMA AF 222 then sends a Naanf_AKMA_ApplicationKey_Get request message 912 to AAnF 536 with the A-KID 804 to request the K_{AF} key for UE 106. AKMA AF 222 also includes its identity (AF_ID) in the request.

AAnF 536 checks whether it can provide the AKMA service to the AKMA AF 222 based on the configured local policy or based on the authorization information available in the signaling. If it succeeds, then the following procedures are executed. Otherwise, AAnF 536 rejects the procedure. AAnF 536 verifies whether the subscriber is authorized to use AKMA based on the presence of the UE-specific K_{AKMA} key 803 identified by the A-KID 804. AAnF 536 derives the Application Function (AF) key (i.e., K_{AF} key 905) from the K_{AKMA} key 803 if it does not already have the K_{AF} key 905, and sends an Naanf_AKMA_ApplicationKey_Get response message 913 to AKMA AF 222 with the SUPI, the K_{AF} key 905, and a K_{AF} expiration time. AKMA AF 222 sends an AKMA response (e.g., the Application Session Establishment Response message 914) to UE 106.

The above AKMA procedures are described in Release 17 of the 3GPP. However, roaming aspects are not considered in Release 17. In embodiments described herein, enhanced AKMA procedures are set forth to address restriction of AKMA services to (based on Release 17 requirements) roaming UEs, considering access types of UEs and/or other factors.

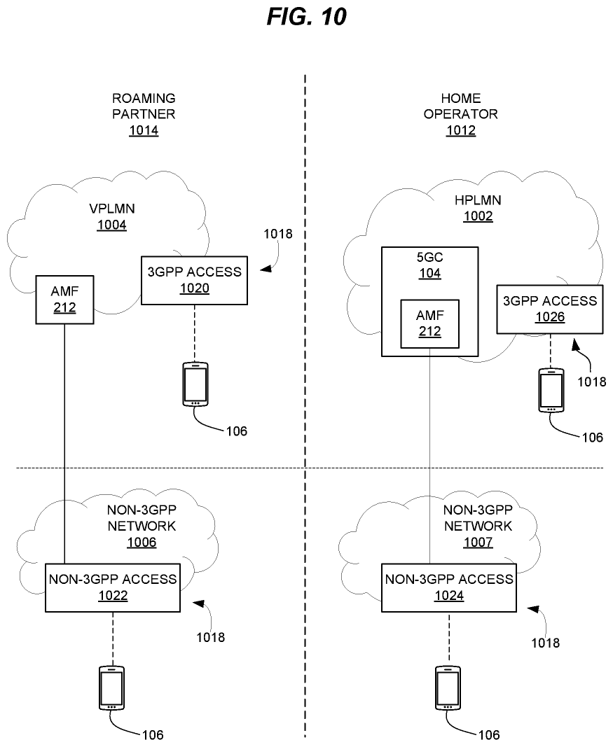

FIG. 10 illustrates non-roaming and roaming scenarios for a UE 106. Roaming extends the coverage of a home operator's services, allowing mobile users to use those services within another network. A UE 106 of a 5G system has a home mobile network (e.g., HPLMN 1002), and the UE 106 may access services when located in the coverage area of the HPLMN 1002. An HPLMN 1002 is the PLMN in which the profile of a mobile subscriber is held. When a user roams onto another network (referred to as a visited network) different than the HPLMN 1002, the 5G Core Network (5GC) 104 of the HPLMN 1002 is able to interconnect or interwork with the visited network so that the user can access services even when roaming outside of HPLMN 1002. For example, the 5GC 104 of the HPLMN 1002 is able to interconnect or interwork with a 5GC (not shown) of VPLMN 1004 (or another PLMN not shown), or interconnect with one or more non-3GPP networks 1006. It may be assumed in FIG. 10 that there is a service agreement or roaming agreement between the home network operator 1012 of the HPLMN 1002 and the roaming partner 1014 of the VPLMN 1004, and/or with other serving networks.

5G systems are designed to enable convergent access-agnostic service availability for a UE 106. A UE 106 may have service availability through different access types, such as 3GPP access and non-3GPP access. 3GPP access means that services are available over the 3GPP licensed spectrum (e.g., 5G services are available to a UE over the 5G New Radio (NR) air interface of a PLMN). Non-3GPP access means that services are available to a UE through another type of access, such as radio over the unlicensed spectrum (e.g., WLAN access (e.g., IEEE 802.11 (Wi-Fi))), fixed access, etc. The following types of non-3GPP networks are: untrusted non-3GPP networks, trusted non-3GPP networks, and wireline networks.

In FIG. 10, a UE 106 roaming in VPLMN 1004 may have connectivity to the VPLMN 1004 through 3GPP access 1020 (i.e., the VPLMN 1004 represents the serving network 306 of UE 106). A UE 106 roaming in a non-3GPP network 1006 may additionally or alternatively have service availability through the non-3GPP network 1006 (e.g., WLAN access network). A non-3GPP network is connected to a 5GC of a PLMN. For example, non-3GPP network 1006 is connected to the 5GC of VPLMN 1004, and VPLMN 1004 represents the serving network 306 of UE 106 (as illustrated by the AMF 212 in VPLMN 1004). When a UE is “connected” to the 5GC of a PLMN, the UE is registered in an AMF 212 of that PLMN. As illustrated in FIG. 10, a roaming UE 106 may have service availability through at least one of 3GPP access 1020 through VPLMN 1004, and non-3GPP access 1022 through a non-3GPP network 1006 connected to VPLMN 1004.

A non-roaming UE 106 may have connectivity to the HPLMN 1002 through 3GPP access 1026 (i.e., the HPLMN 1002 represents the serving network 306 and home network 304 for UE 106). Additionally or alternatively, a roaming UE 106 may have service availability through a non-3GPP network 1007 (e.g., WLAN access network) connected to 5GC 104 of HPLMN 1002 (i.e., the HPLMN 1002 represents the serving network 306 illustrated by the AMF 212 in HPLMN 1002). A UE 106 may therefore have non-3GPP access 1024 through a non-3GPP network 1007 connected to HPLMN 1002. The 3GPP access 1020 and non-3GPP access 1022 through VPLMN 1004, and the 3GPP access 1026 and non-3GPP access 1024 through HPLMN 1002 may be considered different access types 1018 for a UE 106. Those skilled in the art will appreciate that non-3GPP access types may be further segmented into trusted, untrusted, and wireline access.

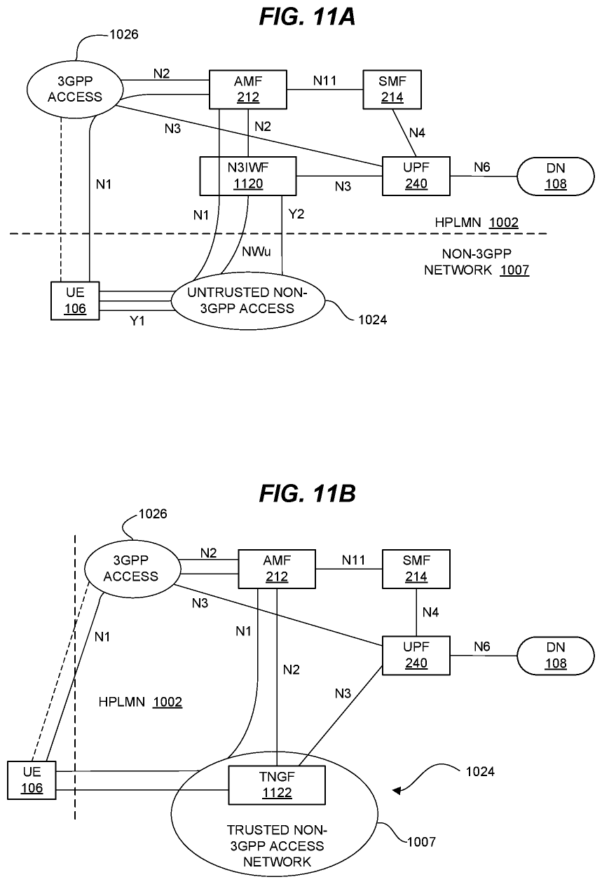

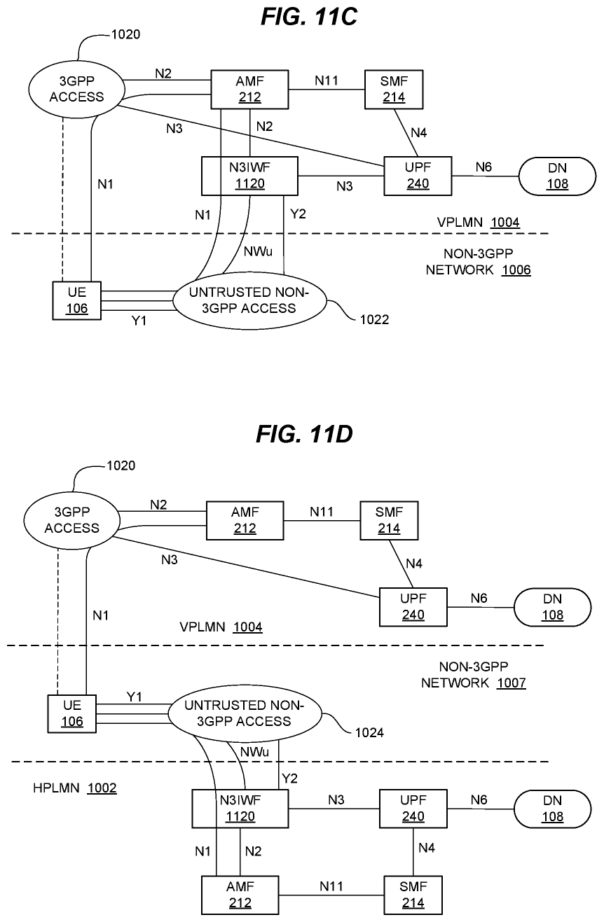

FIGS. 11A-11B illustrate non-roaming architectures. FIG. 11A illustrates a non-roaming architecture with untrusted non-3GPP access. In this architecture, a UE 106 has service availability via 3GPP access 1026 and (untrusted) non-3GPP access 1024. An untrusted non-3GPP access network is connected to a 5GC via a Non-3GPP InterWorking Function (N3IWF). In FIG. 11A, a non-3GPP network 1007 is connected to the 5GC (e.g., AMF 212) of HPLMN 1002 via a N3IWF 1120. FIG. 11B illustrates a non-roaming architecture with trusted non-3GPP access. In this architecture, a UE 106 again has service availability via 3GPP access 1026 and (trusted) non-3GPP access 1024. A trusted non-3GPP network 1007 is connected to a 5GC via a Trusted Non-3GPP Gateway Function (TNGF). In FIG. 11B, a non-3GPP network 1007 is connected to the 5GC 104 (e.g., AMF 212) of HPLMN 1002 via TNGF 1122.

FIGS. 11C-11D illustrate roaming architectures. FIG. 11C illustrates a local breakout scenario (LBO) roaming architecture with untrusted non-3GPP access. In this architecture, a UE 106 has service availability via 3GPP access 1020 and (untrusted) non-3GPP access 1022. Non-3GPP network 1006 is connected to the 5GC (i.e., AMF 212) of VPLMN 1004 via a N3IWF 1120 in the same PLMN (i.e., VPLMN 1004) as 3GPP access 1020. FIG. 11D illustrates another LBO roaming architecture with untrusted non-3GPP access. In this architecture, a UE 106 again has service availability via 3GPP access 1020 and (untrusted) non-3GPP access 1024. In FIG. 11B, non-3GPP network 1007 is connected to the 5GC 104 of HPLMN 1002 via a N3IWF 1120 in a different PLMN (i.e., HPLMN 1002) as 3GPP access 1020. Thus, UE 106 is roaming when connected to VPLMN 1004 via 3GPP access, and is not roaming when connected to HPLMN 1002 via non-3GPP access 1024. Other roaming architectures provided in 3GPP TS 23.501 for LBO and home-routed scenarios may be considered herein, but are not discussed for the sake of brevity.

In embodiments described herein, AKMA services may be restricted when a UE 106 is roaming, even if the UE 106 supports AKMA services.

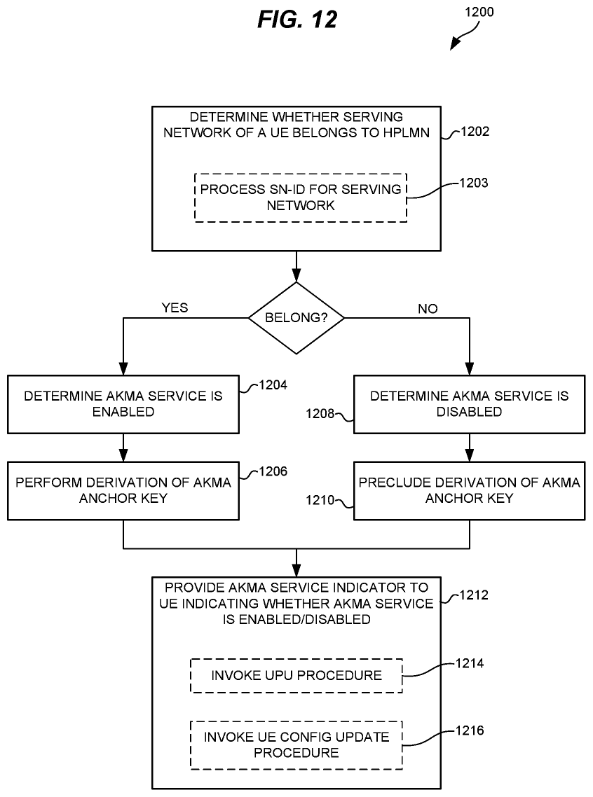

FIG. 12 is a flow chart illustrating a method 1200 of performing an AKMA procedure in an illustrative embodiment. The steps of method 1200 will be described with reference to the HPLMN 1002 of a UE 106. The steps of the flow charts described herein are not all inclusive and may include other steps not shown, and the steps may be performed in an alternative order.

As described in FIGS. 3-4, a UE 106 attempts to register with a serving network 306, such as by sending an initial NAS message to an AMF 212 of the serving network 306. The AMF 212 of the serving network 306 initiates authentication by sending an authentication request to the HPLMN 1002 (e.g., sending a Nausf_UEAuthentication_Authenticate Request message 312 to AUSF 210). The HPLMN 1002 then initiates primary authentication of the UE 106.

In an embodiment, during primary authentication of the UE 106, the HPLMN 1002 determines whether the serving network 306 of UE 106 (i.e., the serving network 306 through which UE 106 attempts to register) belongs to the HPLMN 1002 of UE 106 (step 1202). For example, the UDM 218 of the HPLMN 1002 receives the serving network name (SN-Name) in signaling from the serving network 306. UDM 218 may process the SN-Name or a serving network identity (SN-ID) of the SN-Name (optional step 1203), such as by comparing the SN-Name or SN-ID with a PLMN list of the home operator 1012 to determine whether the serving network 306 belongs to the PLMN list. The HPLMN 1002 therefore determines in step 1202 whether the UE 106 is roaming outside of the HPLMN 1002 (i.e., registration of UE 106 is with an AMF 212 outside of the HPLMN 1002).

Responsive to a determination that the serving network 306 belongs to the HPLMN 1002, the HPLMN 1002 determines that an AKMA service is enabled for a registration of UE 106 with the serving network 306 (step 1204). The HPLMN 1002 performs derivation of the AKMA anchor key (i.e., the K_{AKMA} key 803) when the AKMA service is enabled (step 1206) after primary authentication is successfully completed. For example, UDM 218 may provide an authentication response to AUSF 210 with an AKMA indication 801 and the RID 802 of UE 106 when the AKMA service is enabled. AUSF 210, in turn, generates the K_{AKMA} key 803 and the A-KID 804 from the K_{AUSF} key after the primary authentication procedure is successfully completed.

Responsive to a determination that the serving network 306 does not belong to the HPLMN 1002, the HPLMN 1002 determines that the AKMA service is disabled for the registration of the UE 106 with the serving network 306 (step 1208). The HPLMN 1002 precludes or prohibits derivation of the AKMA anchor key when the AKMA service is disabled (step 1210). For example, UDM 218 may omit or exclude the AKMA indication 801 and/or the RID 802 from the authentication response provided to AUSF 210 when the AKMA service is disabled. AUSF 210, in turn, will not generate the K_{AKMA} key 803 after the primary authentication procedure is successfully completed.

One technical benefit is, although a UE 106 supports an AKMA service, the AKMA service may be selectively enabled or disabled by the HPLMN 1002 for individual registrations of the UE 106 with a serving network 306.

After primary authentication is successful, HPLMN 1002 provides an AKMA service indicator to UE 106 indicating whether the AKMA service is enabled or disabled (step 1212). An AKMA service indicator may comprise a value, string, etc., that indicates to a UE whether an AKMA service is enabled or disabled. In one embodiment, HPLMN 1002 may provide the AKMA service indicator to UE 106 by invoking or using a UE Parameters Update (UPU) procedure (optional step 1214). In one embodiment, HPLMN 1002 may provide the AKMA service indicator to UE 106 by invoking or using a UE configuration update procedure (optional step 1216). However, other procedures or services may be invoked or used to provide the AKMA service indicator to UE 106. UE 106 generates or does not generate the K_{AKMA} key 803 after primary authentication is successfully completed, based on the AKMA service indicator provided by HPLMN 1002.

The following describes further details for managing an AKMA service. In general, the network functions/elements involved in AKMA services may include a UDM 218 and AAnF 536 of the HPLMN 1002, and the UE 106. Block diagrams for these network functions/elements and UE 106 are provided in FIGS. 13-15.

FIG. 13 is a block diagram of a UDM 218 in an illustrative embodiment. UDM 218 is a network element or network function configured to manage network user data within the 5G core network 104. In this embodiment, UDM 218 includes the following subsystems: a network interface component 1302, and a data management controller 1304 that operate on one or more platforms. Network interface component 1302 may comprise circuitry, logic, hardware, means, etc., configured to exchange control plane messages or signaling with other network elements and/or UEs. Network interface component 1302 may operate using a variety of protocols or reference points. Data management controller 1304 may comprise circuitry, logic, hardware, means, etc., configured to support services, operations, procedures, or functions of a UDM.

One or more of the subsystems of UDM 218 may be implemented on a hardware platform comprised of analog and/or digital circuitry. For example, data management controller 1304 may be implemented on one or more processors 1330 that execute instructions 1334 (i.e., computer readable code) for software that are loaded into memory 1332. A processor 1330 comprises an integrated hardware circuit configured to execute instructions 1334 to provide the functions of UDM 218. Processor 1330 may comprise a set of one or more processors or may comprise a multi-processor core, depending on the particular implementation. Memory 1332 is a non-transitory computer readable storage medium for data, instructions, applications, etc., and is accessible by processor 1330. Memory 1332 is a hardware storage device capable of storing information on a temporary basis and/or a permanent basis. Memory 1332 may comprise a random-access memory, or any other volatile or non-volatile storage device. One or more of the subsystems of UDM 218 may be implemented on a cloud-computing platform or another type of processing platform.

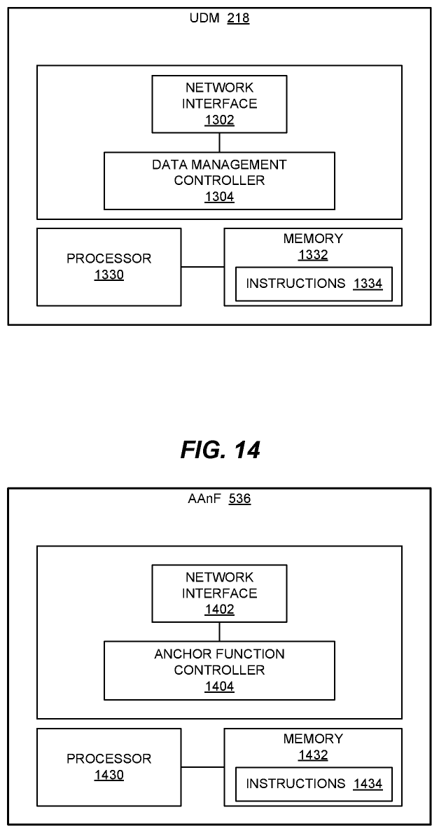

UDM 218 may include various other components not specifically illustrated in FIG. 13. FIG. 14 is a block diagram of an AAnF 536 in an illustrative embodiment. AAnF 536 is a network element or network function configured to generate the key material to be used between a UE and an AF, and maintain UE AKMA contexts. In this embodiment, AAnF 536 includes the following subsystems: a network interface component 1402, and an anchor function controller 1404 that operate on one or more platforms. Network interface component 1402 may comprise circuitry, logic, hardware, means, etc., configured to exchange control plane messages or signaling with other network elements and/or UEs. Network interface component 1402 may operate using a variety of protocols (including NAS protocol) or reference points. Anchor function controller 1404 may comprise circuitry, logic, hardware, means, etc., configured to support operations, procedures, or functions of an AKMA service. One or more of the subsystems of AAnF 536 may be implemented on a hardware platform comprised of analog and/or digital circuitry. One or more of the subsystems of AAnF 536 may be implemented on one or more processors 1430 that execute instructions 1434 (i.e., computer readable code) for software that are loaded into memory 1432. One or more of the subsystems of AAnF 536 may be implemented on a cloud-computing platform or another type of processing platform.

AAnF 536 may include various other components not specifically illustrated in FIG. 14.

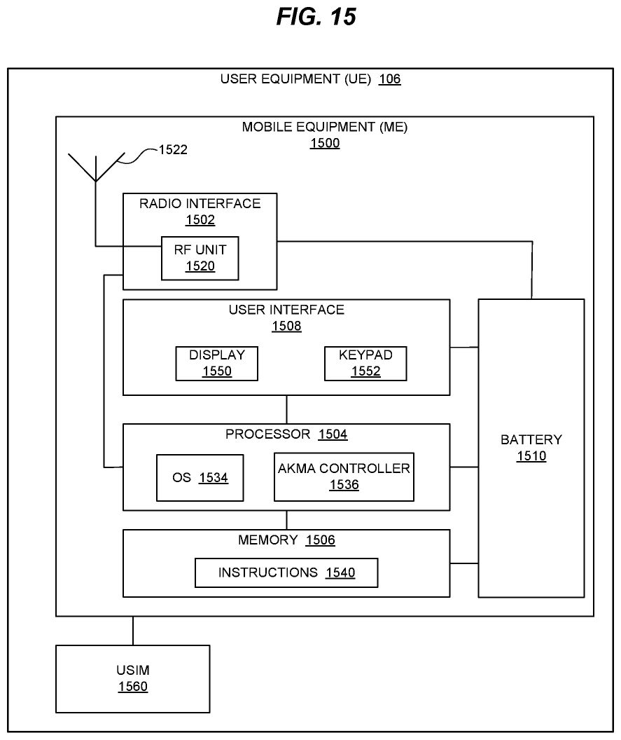

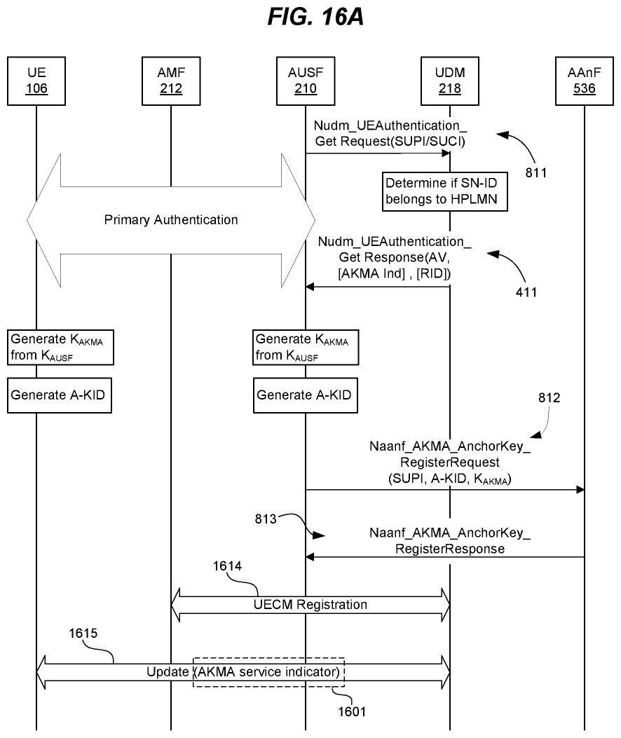

FIG. 15 is a block diagram of a UE 106 in an illustrative embodiment. From a functional standpoint, UE 106 is composed of at least two parts: Mobile Equipment (ME) 1500 and a Universal Subscriber Identity Module (USIM) 1560. ME 1500 includes a radio interface component 1502, one or more processors 1504, a memory 1506, and a user interface component 1508. UE 106 may also comprise a battery 1510. Radio interface component 1502 is a hardware component that represents the local radio resources of UE 106, such as an RF unit 1520 (e.g., one or more radio transceivers) and one or more antennas 1522. Radio interface component 1502 may be configured for WiFi, Bluetooth, 5G NR, LTE, satellite, etc. Processor 1504 represents the internal circuitry, logic, hardware, means, etc., that provides the functions of UE 106. Processor 1504 may be configured to execute instructions 1540 for software that are loaded into memory 1506. Processor 1504 may execute an Operating System (OS) 1534 for UE 106 that manages hardware and software resources, and one or more applications. Processor 1504 may implement an AKMA controller 1536 configured to control an AKMA service from the UE point of view. User interface component 1508 is a hardware component for interacting with an end user. For example, user interface component 1508 may include a display 1550, screen, touch screen, or the like (e.g., a Liquid Crystal Display (LCD), a Light Emitting Diode (LED) display, etc.). User interface component 1508 may include a keyboard or keypad 1552, a tracking device (e.g., a trackball or trackpad), a speaker, a microphone, etc. USIM 1560 is an integrated circuit that provides security and integrity functions for UE 106. USIM 1560 includes or is provisioned with a subscription profile associated with a subscription of a subscriber. A subscription profile may include a variety of information, such as subscription credentials (e.g., SUPI) used to uniquely identify a subscription and to mutually authenticate the UE 106 and a network.

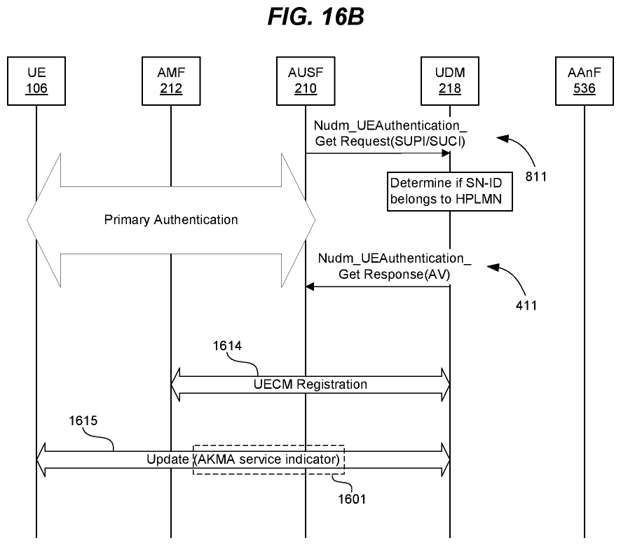

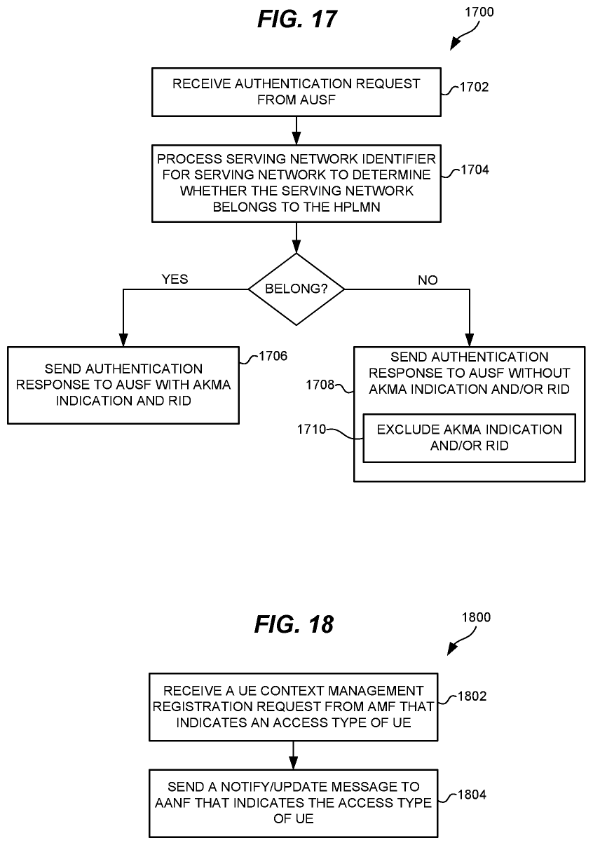

UE 106 may include various other components not specifically illustrated in FIG. 15. FIGS. 16A-16B are message diagrams illustrating an AKMA procedure in an illustrative embodiment. Some functions performed in FIGS. 16A-16B are similar to FIG. 8 described above. However, access to AKMA services may be restricted or limited based on a roaming status of UE 106. FIG. 17 is a flow chart illustrating a method 1700 of managing an AKMA service in an illustrative embodiment. The steps of method 1700 will be described with reference to UDM 218 in FIG. 13.

During the primary authentication procedure of a UE 106 in FIG. 16A, AUSF 210 interacts with UDM 218 in order to fetch authentication information, such as subscription credentials (e.g., AKA Authentication vectors) and the authentication method using the Nudm_UEAuthentication_Get Request service operation. In FIG. 17, data management controller 1304 of UDM 218 receives an authentication request (e.g., Nudm_UEAuthentication_Get Request 811) from AUSF 210 (step 1702), such as through network interface component 1302. In response to the authentication request, data management controller 1304 of UDM 218 processes a serving network identifier for serving network 306 to determine whether the serving network 306 belongs to the HPLMN 1002 (step 1704). Responsive to a determination that the serving network 306 belongs to the HPLMN 1002, data management controller 1304 determines that the AKMA service is enabled and sends an authentication response (e.g., Nudm_UEAuthentication_Get Response 411) to AUSF 210 with the AKMA indication 801 and the RID 802 of UE 106 (step 1706), as shown in FIG. 16A. Responsive to a determination that the serving network 306 does not belong to the HPLMN 1002, data management controller 1304 determines that the AKMA service is disabled and sends the authentication response to AUSF 210 without the AKMA indication 801 and/or the RID 802 of UE 106 (step 1708), as shown in FIG. 16B. In other words, data management controller 1304 sends the authentication response to AUSF 210 with the subscription credentials (e.g., authentication vectors (AV)), but omits or excludes at least one of the AKMA indication 801 and the RID 802 (step 1710). A technical benefit is the UDM 218 is able to manage derivation of the K_{AKMA} key 803 based on whether the serving network 306 belongs to the HPLMN 1002 (e.g., whether the UE 106 is roaming for the registration with the serving network 306).

If AUSF 210 receives the AKMA indication 801 and RID 802 from UDM 218 as in FIG. 16A, then AUSF 210 stores the K_{AUSF} key and generates the K_{AKMA} key 803 and the A-KID 804 from the K_{AUSF} key after the primary authentication procedure is successfully completed. After the AKMA key material is generated, AUSF 210 selects the AAnF 536 and sends the A-KID 804 and the K_{AKMA} key 803 to AAnF 536 along with the SUPI of UE 106 using an Naanf_AKMA_AnchorKey_Register Request message 812. AAnF 536 will then store the SUPI, K_{AKMA} key 803, and A-KID 804 in an AKMA context associated with the SUPI. An AKMA context is a set of parameters stored in AAnF 536, including the SUPI, the K_{AKMA} key 803, and the A-KID 804. If AUSF 210 does not receive the AKMA indication 801 and/or the RID 802 from UDM 218 as in FIG. 16B, then AUSF 210 does not generate the K_{AKMA} key 803 after the primary authentication procedure is successfully completed. AUSF 210 therefore does not select an AAnF 536 and an AKMA context is not created.

After primary authentication is successful, UDM 218 may update the AKMA context for the UE 106 at AAnF 536 with the access type 1018 for UE 106. FIG. 18 is a flow chart illustrating a method 1800 of updating an AKMA context in an illustrative embodiment. The steps of method 1800 in FIG. 18 will be described with reference to UDM 218 in FIG. 13.

In one embodiment, after successful primary authentication, data management controller 1304 of UDM 218 receives a UE context management registration request, or another type of request, from AMF 212 of HPLMN 1002 (step 1802), such as through network interface component 1302. The UE context management registration request indicates an access type 1018 of UE 106. Data management controller 1304 sends a notify or update message to AAnF 536 that indicates the access type 1018 of UE 106 registered with the serving network 306 (step 1804), such as through network interface component 1302. A technical benefit is the UDM 218 is able to inform the AAnF 536 of the access type registered with serving network 306 in order to update the AKMA context.

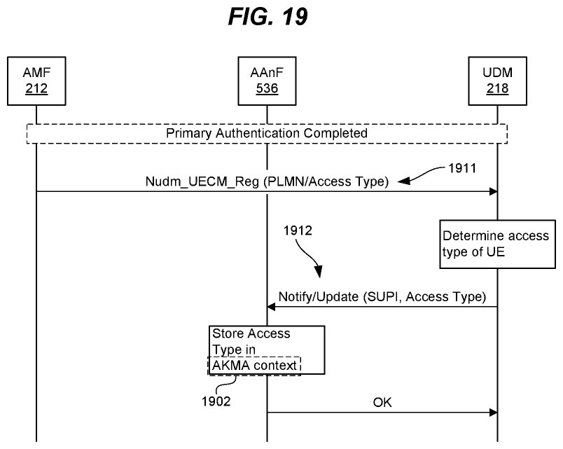

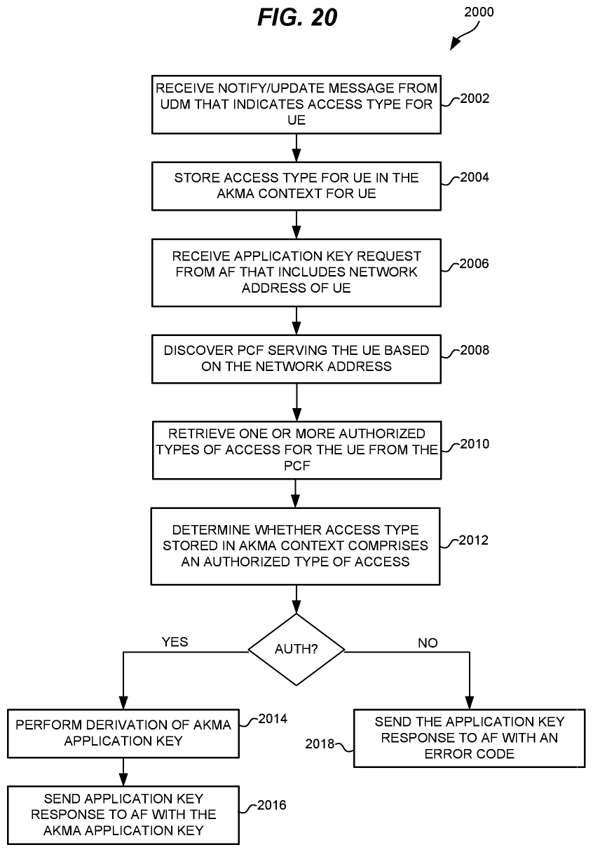

As shown in FIGS. 16A-16B, the AKMA context for the UE 106 stored at AAnF 536 may be updated during a UE Context Management (UECM) registration procedure 1614. FIG. 19 is a message diagram illustrating an update to an AKMA context in an illustrative embodiment. In one embodiment, AMF 212 (i.e., the home AMF) triggers an Nudm_UECM_Registration service operation by sending an Nudm_UECM_Registration request message 1911 to UDM 218, which includes the access type 1018 of UE 106. UDM 218 determines the access type 1018 of UE 106 based on information provided by AMF 212 in the Nudm_UECM_Registration request message 1911. UDM 218 then sends a notify or update message 1912 to AAnF 536 that includes the SUPI and the access type 1018 of UE 106. FIG. 20 is a flow chart illustrating a method 2000 of updating an AKMA context in an illustrative embodiment. The steps of method 2000 in FIG. 20 will be described with reference to AAnF 536 in FIG. 14. Anchor function controller 1404 of AAnF 536 receives the notify or update message 1912 from UDM 218 (step 2002), such as through network interface component 1402. Anchor function controller 1404 then stores the access type 1018 for UE 106 in the AKMA context 1902 for UE 106 that is associated with the SUPI (step 2004). A technical benefit is the AKMA context 1902 indicates the access type 1018 registered for UE 106 in the serving network 306.

Additionally, after primary authentication is successful in FIGS. 16A-16B, HPLMN 1002 instructs UE 106 whether or not to generate or derive the AKMA Anchor Key (i.e., K_{AKMA} key 803). To do so, HPLMN 1002 provides an update 1615 to UE 106 with an AKMA service indicator 1601 that indicates to UE 106 whether or not the AKMA service is enabled or disabled.

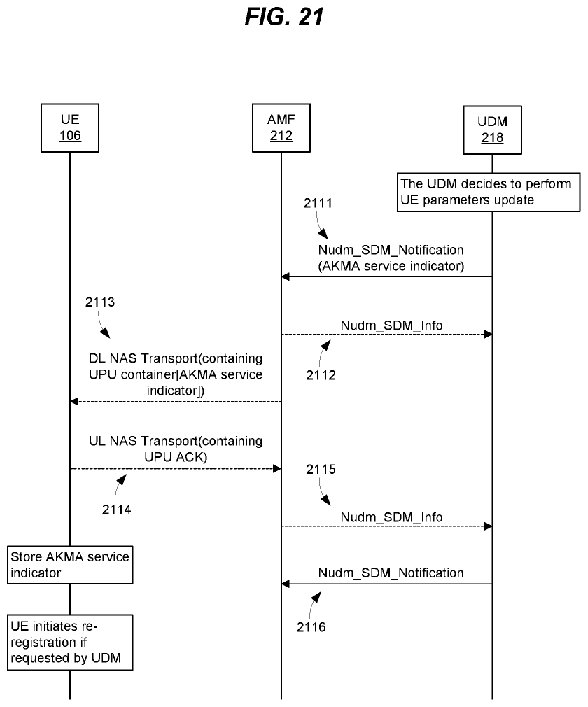

In one embodiment, HPLMN 1002 may invoke or use a UPU procedure to provide the update 1615 to UE 106 with the AKMA service indicator 1601. FIG. 21 is a message diagram illustrating a UPU procedure to provide an AKMA service indicator 1601 to a UE 106 in an illustrative embodiment. UDM 218 decides to perform a UE parameters update. For example, UDM 218 may decide whether to perform a UE parameters update based on a local policy regarding AKMA services. UDM 218 may notify the changes of the information related to UE 106 to the affected AMF 212 by the means of invoking the Nudm_SDM_Notification service operation. The Nudm_SDM_Notification service operation contains the UDM Update Data to be delivered transparently to UE 106 over NAS within the Access and Mobility Subscription data. The UDM Update Data includes the updated parameters to be delivered to the UE 106, whether the UE 106 needs to send an ACK to the UDM 218, and whether the UE 106 needs to re-register after updating the data. In an embodiment, the UDM Update Data further includes AKMA service indicator 1601. Thus, UDM 218 sends a notification message (e.g., Nudm_SDM_Notification 2111) to AMF 212 with the AKMA service indicator 1601. UDM 218 may include a UPU transparent container with the AKMA service indicator 1601 if AMF 212 supports UPU transparent containers, or may include an individual Information Element (IE) comprising the AKMA service indicator 1601.

When AMF 212 determines that the UE 106 is not reachable, AMF 212 invokes the Nudm_SDM_Info service operation to UDM 218 indicating that the transmission of UE Parameters Update data is not successful (i.e., Nudm_SDM_Info message 2112). UDM 218 then considers the UE Parameters Update procedure as pending.

When AMF 212 determines that the UE 106 is reachable, AMF 212 sends a DL NAS transport message 2113 to the UE 106. AMF 212 includes the transparent container received from UDM 218 in the DL NAS transport message 2113. UE 106 verifies that the UDM Update Data is provided by HPLMN 1002. If the security check on the UDM Update Data is successful, UE 106 either stores the information (including the AKMA service indicator 1601) and uses those parameters from that point onwards, or forwards the information to the USIM 1560. If the security check on the UDM Update Data fails, then UE 106 discards the contents of the UDM Update Data. If the UE 106 has verified that the UDM Update Data is provided by HPLMN 1002 and UDM 218 has requested the UE 106 to send an acknowledgement (ACK), then UE 106 sends an UL NAS transport message 2114 to the serving AMF 212 with a transparent container including the UE acknowledgement.

If AMF 212 receives an UL NAS transport message 2114 with a transparent container carrying a UE acknowledgement from UE 106, then AMF 212 sends a Nudm_SDM_Info request message 2115 including the transparent container to UDM 218. If the UE parameters update is performed due to “Routing Indicator update data”, then the updated Routing Indicator value is also supported by UDM 218 where AMF 212 is currently registered and UDM 218 requests UE 106 to send an ACK but does not request the UE 106 to re-register, then upon reception of the transparent container indicating the acknowledgement of successful reception, UDM 218 triggers a Nudm_SDM_Notification service operation to update the UE Context in AMF 212 with the updated Routing Indicator Data (i.e., Nudm_SDM_Notification 2116). If UDM 218 requested the UE 106 to re-register, then UE 106 waits until it goes back to RRC idle and initiates a Registration procedure.

A technical benefit is UDM 218 is able to inform UE 106 whether an AKMA service is enabled/disabled via the UE parameters update procedure.

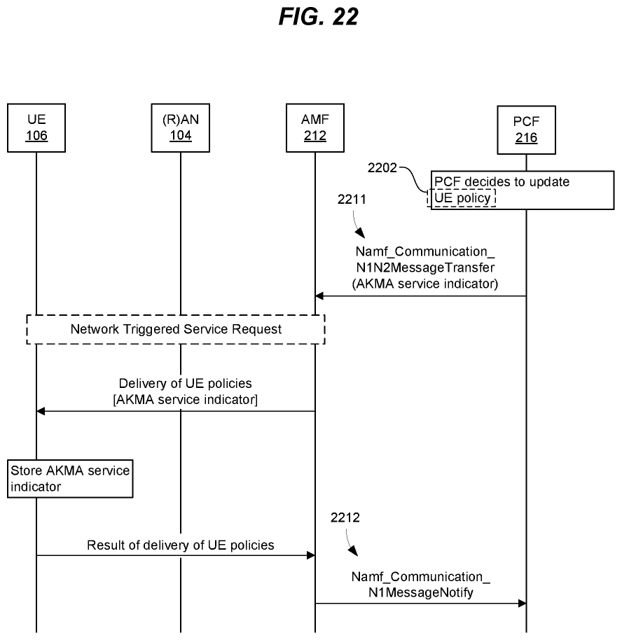

In one embodiment, HPLMN 1002 may invoke or use a UE configuration update procedure to provide the update 1615 to UE 106 with the AKMA service indicator 1601. A UE configuration may be updated by the network at any time using the UE Configuration Update procedure. The UE configuration may include Access and Mobility Management related parameters, and a UE Policy provided by PCF 216. When PCF 216 wants to change or provide new UE Policies in UE 106, PCF 216 initiates the UE Configuration Update procedure. FIG. 22 is a message diagram illustrating a UE configuration update procedure to provide an AKMA service indicator 1601 to a UE 106 in an illustrative embodiment.

PCF 216 decides to update the UE policy 2202 based on triggering conditions, such as an initial registration, registration with the 5GS when the UE 106 moves from the Evolved Packet System (EPS) to the 5GS, registration based on change in PLMN (i.e., UE 106 moves from one PLMN to another PLMN), registration based on change in access type 1018, or need for updating UE policy 2202. For the case of initial registration and registration with the 5GS when UE 106 moves from EPS to 5GS, PCF 216 compares the list of PDU session identities (PSIs) included in the UE policy information in Npcf_UEPolicyControl_Create request and determines whether UE policy information has to be updated and be provided to UE 106 via the AMF 212 using a DL NAS transport message. For the network triggered UE policy update case (e.g., change of UE location, the change of Subscribed S-NSSAIs), PCF 216 checks the latest list of PSIs to decide which UE policies 2202 have to be sent to UE 106.

PCF 216 invokes the Namf_Communication_N1N2MessageTransfer service operation to send UE policy information to AMF 212 (i.e., Namf_Communication_N1N2MessageTransfer message 2211). The Namf_Communication_N1N2MessageTransfer message 2211 includes the SUPI and a UE Policy Container. In an embodiment, PCF 216 includes the AKMA service indicator 1601 in the UE Policy container. When UE 106 is registered and reachable by AMF 212 in either 3GPP access or non-3GPP access, AMF 212 transfers the UE Policy container transparently to UE 106 via the registered and reachable access. When UE 106 is registered in both 3GPP access and non-3GPP access and reachable on both 3GPP access and non-3GPP access and served by the same AMF, AMF 212 transfers the UE Policy container transparently to UE 106 via one of the accesses based on the AMF local policy. When UE 106 is not reachable by AMF 212 over either 3GPP access or non-3GPP access, AMF 212 reports to PCF 216 that the UE Policy container could not be delivered to UE 106 using Namf_Communication_N1N2TransferFailureNotification.

If UE 106 is in CM-CONNECTED state over 3GPP access or non-3GPP access, AMF 212 transfers or delivers the UE Policy container (UE policy information) received from PCF 216 to UE 106. In an embodiment, the UE policy information delivered to UE 106 includes the AKMA service indicator 1601. UE 106 updates the UE policy 2202 provided by PCF 216 and sends the result to AMF 212. AMF 212 forwards the response of UE 106 to PCF 216 using Namf_Communication_N1MessageNotify message 2212.

A technical benefit is if there is change in PLMN or change in access type 1018 of a UE 106, both detected via new registration, PCF 216 is able to determine whether an AKMA service is enabled/disabled with the new registration, and inform UE 106 via the UE configuration update procedure.

It is noted that the HPLMN 1002 may provide the AKMA service indicator 1601 to UE 106 in other ways.

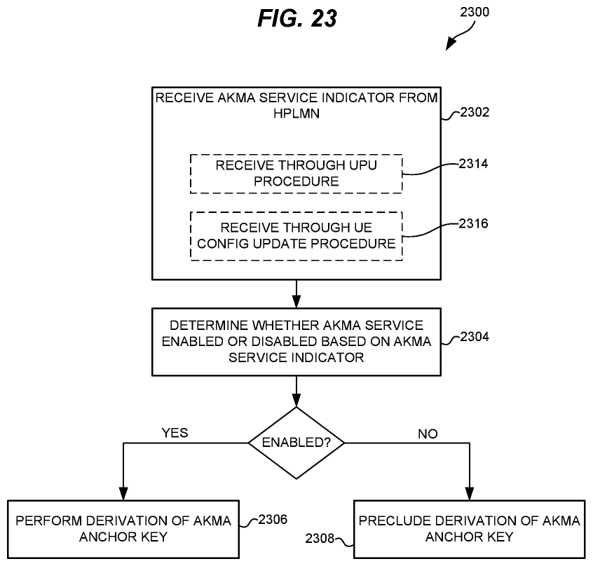

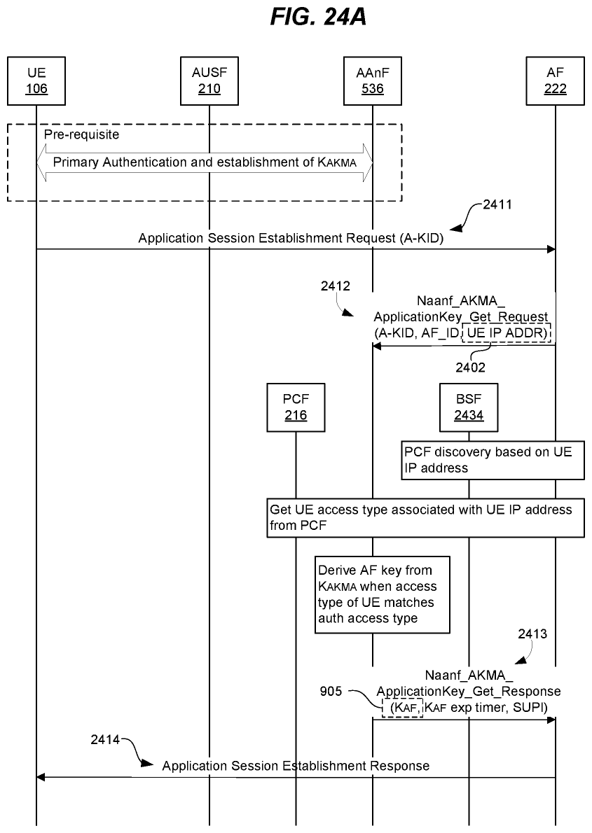

FIG. 23 is a flow chart illustrating a method 2300 of updating a UE 106 in an illustrative embodiment. The steps of method 2300 in FIG. 23 will be described with reference to UE 106 in FIG. 15. UE 106 receives the AKMA service indicator 1601 from HPLMN 1002 (step 2302). As described above, UE 106 may receive the AKMA service indicator 1601 through a UPU procedure (optional step 2314), through a UE configuration update procedure (optional step 2316), or through another procedure. UE 106 determines whether the AKMA service is enabled or disabled based on the AKMA service indicator 1601 (step 2304).

Responsive to a determination that the AKMA service is enabled, UE 106 performs derivation of the AKMA anchor key (i.e., the K_{AKMA} key 803) (step 2306) after primary authentication is successfully completed. Responsive to a determination that the AKMA service is disabled, UE 106 precludes or prohibits derivation of the AKMA anchor key (step 2308). A technical benefit is the UE 106 is informed of the status of AKMA services for a registration with the serving network 306 based on the AKMA service indicator 1601 provided by the HPLMN 1002. Thus, the UE 106 should not try to invoke the AKMA service with an AF 222 for an application session over that serving network 306.

After primary authentication is successfully completed, UE 106 may request an application session with an AF 222 (also referred to as an AKMA AF), or an AF 222 may request an application session with UE 106. In one embodiment, AAnF 536 provides control over whether an AKMA Application Key (i.e., K_{AF} key) is generated for the AF 222.

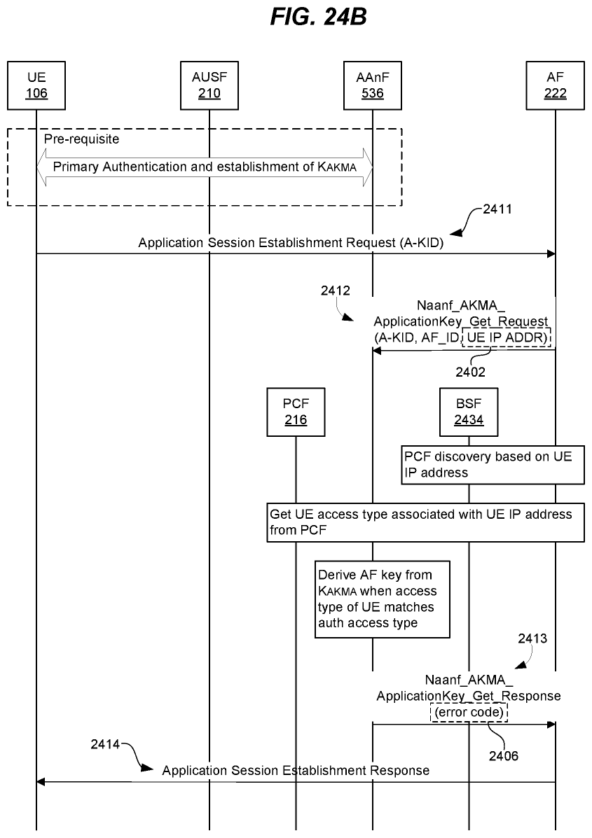

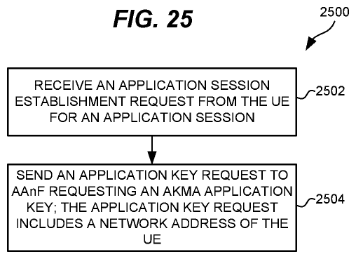

FIGS. 24A-24B are signaling diagrams illustrating key generation for an AKMA service in an illustrative embodiment. More particularly, FIGS. 24A-24B illustrate generating of the AKMA Application Key (i.e., K_{AF} key) for an AF 222 located in the HPLMN 1002. FIG. 25 is a flow chart illustrating a method 2500 of managing key generation at an AF 222 in an illustrative embodiment.

A pre-requisite is that primary authentication is successful and establishment of the K_{AKMA} key 803 is performed. Before communication between UE 106 and AF 222 can start, UE 106 and the AF 222 need to know whether to use AKMA. This knowledge may be implicit to the specific application on UE 106 and the AF 222, indicated by the AF 222 to UE 106, and/or based on the AKMA service indicator 1601.

Before initiating communication with an AF 222, UE 106 generates the K_{AKMA} key 803 and the A-KID 804 from the K_{AUSF} key (for example, if AKMA is enabled). To initiate a communication, UE 106 sends an Application Session Establishment Request message 2411 to the AF 222 with the A-KID 804. UE 106 may derive the K_{AF} key before or after sending the Application Session Establishment Request message 2411.

AF 222 receives the Application Session Establishment Request message 2411 from UE 106 for an application session (step 2502 of FIG. 25). If the AF 222 does not have an active AKMA context associated with the A-KID 804, then AF 222 selects the AAnF 536 and sends an application key request to AAnF 536 requesting an K_{AF} key for the application session (step 2504). AF 222 includes or inserts a network address of UE 106 (e.g., a network-assigned UE IP address) in the application key request. As shown in FIG. 24A, AF 222 sends a Naanf_AKMA_ApplicationKey_Get request message 2412 to AAnF 536 with the A-KID 804, an AF identity (AF_ID), and a network address 2402 (e.g., UE IP address) to request the K_{AF} key for UE 106. AAnF 536 checks whether the AAnF 536 can provide the AKMA service to AF 222 based on the configured local policy or based on the authorization information available in the signaling. If it succeeds, the following procedures are executed. Otherwise, AAnF 536 rejects the procedure. Also, AAnF 536 verifies whether the subscriber is authorized to use the AKMA service based on the presence of the UE-specific K_{AKMA} key 803 identified by the A-KID 804.

In FIG. 20, anchor function controller 1404 of AAnF 536 receives the application key request from AF 222 (step 2006), such as through network interface component 1402. Anchor function controller 1404 discovers the PCF 216 that is serving UE 106 based on the network address 2402 of UE 106 (step 2008). For example, AAnF 536 may discover the serving PCF 216 from the Binding Support Function (BSF) 2434 by providing the received UE network address 2402, as shown in FIG. 24A. Anchor function controller 1404 then retrieves one or more authorized types of access for UE 106 from PCF 216 (step 2010 of FIG. 20). For example, a UE policy in PCF 216 may define one or more authorized types of access that are authorized to the UE 106 for an AKMA service. In other words, an AKMA service may be authorized between a UE 106 and an AF 222 when the UE 106 registers with the serving network 306 over an authorized type of access. An authorized type of access may comprise 3GPP access connected through HPLMN 1002, non-3GPP access 1024 connected through HPLMN 1002, etc.

Anchor function controller 1404 determines whether the access type 1018 stored in the AKMA context 1902 comprises an authorized type of access (step 2012). When the access type 1018 stored in the AKMA context 1902 comprises an authorized type of access, anchor function controller 1404 performs derivation of the K_{AF} key for the application session (step 2014), and sends an application key response to AF 222 with the K_{AF} key (step 2016). As illustrated in FIG. 24A, AAnF 536 may send a Naanf_AKMA_ApplicationKey_Get response message 2413 to AF 222 with the SUPI, the K_{AF} key 905, and a K_{AF} expiration time. In FIG. 20, when the access type 1018 stored in the AKMA context 1902 does not comprise an authorized type of access, anchor function controller 1404 sends the application key response to AF 222 with an error code (step 2018). As illustrated in FIG. 24B, AAnF 536 may send a Naanf_AKMA_ApplicationKey_Get response message 2413 to AF 222 with an error code 2406. The error code 2406 may comprise a newly-defined error code where the AKMA service is denied due to the access type 1018 of the UE 106. AF 222 then sends an Application Session Establishment Response message 2414 to UE 106. If the information in the Naanf_AKMA_ApplicationKey_Get response message 2413 from AAnF 536 indicates failure of AKMA key request, then AF 222 rejects the Application Session Establishment by including a failure cause in the Application Session Establishment Response message 2414. Afterwards, UE 106 may trigger a new Application Session Establishment request with the latest A-KID 804 to AF 222.

A technical benefit of managing derivation of the K_{AF} key 905 in AAnF 536 as described above is an AKMA service may be limited by AAnF 536 to a certain access type(s) even though an AKMA context is established. Assume, for example, that UE 106 has connectivity via 3GPP access 1020 connected through VPLMN 1004 and non-3GPP access 1024 connected through HPLMN 1002. If non-3GPP access 1024 connected through HPLMN 1002 is an authorized type of access, then AAnF 536 derives the K_{AF} key 905 for the application session and sends the K_{AF} key 905 to the AF 222. If 3GPP access 1020 connected through VPLMN 1004 is not an authorized type of access, then AAnF 536 does not derive the K_{AF} key 905 for the application session, and returns an error code 2406 to AF 222. Thus, the AKMA service may be limited by AAnF 536 to a certain authorized type(s) of access for UE 106. This provides further control of AKMA services in the HPLMN 1002.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device. Although specific embodiments were described herein, the scope of the disclosure is not limited to those specific embodiments. The scope of the disclosure is defined by the following claims and any equivalents thereof.

1. A method of performing an Authentication and Key Management for Applications (AKMA) procedure, the method comprising:
determining, during primary authentication of user equipment, whether a serving network of the user equipment belongs to a home public land mobile network of the user equipment;
responsive to determining that the serving network belongs to the home public land mobile network:
determining, in the home public land mobile network, that an AKMA service is enabled for a registration of the user equipment with the serving network; and
performing, in the home public land mobile network, derivation of an AKMA anchor key; and
responsive to determining that the serving network does not belong to the home public land mobile network:
determining, in the home public land mobile network, that the AKMA service is disabled for the registration of the user equipment with the serving network; and
providing, after the primary authentication is successful, an AKMA service indicator from the home public land mobile network to the user equipment, wherein the AKMA service indicator indicates whether the AKMA service is enabled or disabled for the registration of the user equipment with the serving network.

2. The method of claim 1, wherein providing the AKMA service indicator to the user equipment comprises:
providing the AKMA service indicator from the home public land mobile network to the user equipment by invoking a user equipment parameters update procedure or by invoking a user equipment configuration update procedure.

3. The method of claim 1, further comprising:
receiving, at the user equipment, the AKMA service indicator from the home public land mobile network; and
performing derivation of the AKMA anchor key at the user equipment when the AKMA service indicator indicates that the AKMA service is enabled.

4. The method of claim 1, wherein:
determining whether the serving network of the user equipment belongs to the home public land mobile network comprises processing a serving network identifier for the serving network in a Unified Data Management (UDM) of the home public land mobile network; and
further comprising:
excluding at least one of an AKMA indication and a routing indicator for the user equipment in an authentication response from the UDM to an Authentication Server Function (AUSF) during the primary authentication responsive to determining that the serving network does not belong to the home public land mobile network based on the serving network identifier.

5. The method of claim 1, further comprising:
receiving, after the primary authentication is successful, a UE context management registration request at a Unified Data Management (UDM) of the home public land mobile network from an Access and Mobility Management Function (AMF) of the home public land mobile network, wherein the UE context management registration request indicates an access type of the user equipment registered with the serving network; and
sending a notify or update message from the UDM to an AKMA Anchor Function (AAnF) that indicates the access type.

6. The method of claim 5, further comprising:
receiving the notify or update message at the AAnF; and
storing, at the AAnF, the access type in an AKMA context associated with the user equipment.

7. The method of claim 6, further comprising:
receiving, at an application function, an application session establishment request from the user equipment for an application session; and
sending an application key request from the application function to the AAnF requesting an AKMA application key for the application session, wherein the application key request comprises a network address of the user equipment.

8. The method of claim 7, further comprising:
receiving, at the AAnF, the application key request from the application function;
discovering, at the AAnF, a Policy Control Function (PCF) serving the user equipment based on the network address; and
retrieving, at the AAnF from the PCF, one or more authorized types of access that are authorized to the user equipment for the AKMA service.

9. The method of claim 8, further comprising:
when the access type stored in the AKMA context comprises an authorized type of access:
performing derivation of the AKMA application key at the AAnF for the application session; and
sending an application key response from the AAnF to the application function with the AKMA application key; and
when the access type stored in the AKMA context does not comprise an authorized type of access:
sending the application key response from the AAnF to the application function with an error code.

10. The method of claim 9, wherein:
an authorized type of access comprises 3GPP access connected through the home public land mobile network.

11. The method of claim 9, wherein:
an authorized type of access comprises non-3GPP access connected through the home public land mobile network.

12. A 5G system, comprising:
a home public land mobile network of user equipment that supports Authentication and Key Management for Applications (AKMA);
wherein the home public land mobile network comprises at least one processor, and at least one memory storing instructions that, when executed by the at least one processor, cause the home public land mobile network at least to:
determine, during primary authentication of the user equipment, whether a serving network of the user equipment belongs to the home public land mobile network;
responsive to a determination that the serving network belongs to the home public land mobile network:
determine that an AKMA service is enabled for a registration of the user equipment with the serving network; and
perform derivation of an AKMA anchor key; and
responsive to a determination that the serving network does not belong to the home public land mobile network:
determine that the AKMA service is disabled for the registration of the user equipment with the serving network; and
provide, after the primary authentication is successful, an AKMA service indicator to the user equipment, wherein the AKMA service indicator indicates whether the AKMA service is enabled or disabled for the registration of the user equipment with the serving network.

13. The 5G system of claim 12, wherein the at least one processor further causes the home public land mobile network at least to:
provide the AKMA service indicator to the user equipment by invoking a user equipment parameters update procedure or by invoking a user equipment configuration update procedure.

14. The 5G system of claim 12, wherein the at least one processor implements a Unified Data Management (UDM) configured to:
receive, after the primary authentication is successful, a UE context management registration request from an Access and Mobility Management Function (AMF) of the home public land mobile network, wherein the UE context management registration request indicates an access type of the user equipment registered with the serving network; and
send a notify or update message to an AKMA Anchor Function (AAnF) that indicates the access type.

15. The 5G system of claim 12, wherein the at least one processor implements an AKMA Anchor Function (AAnF) configured to:
receive an update or notify message from a Unified Data Management (UDM) of the home public land mobile network, wherein the update or notify message indicates an access type of the user equipment registered with the serving network; and
store the access type in an AKMA context associated with the user equipment.

16. The 5G system of claim 15, wherein the AAnF is further configured to:
receive an application key request from an application function requesting an AKMA application key for an application session of the user equipment, wherein the application key request comprises a network address of the user equipment;
discover a Policy Control Function (PCF) serving the user equipment based on the network address; and
retrieve, from the PCF, one or more authorized types of access that are authorized to the user equipment for the AKMA service.

17. The 5G system of claim 16, wherein the AAnF is further configured to:
when the access type stored in the AKMA context comprises an authorized type of access:
perform derivation of the AKMA application key for the application session; and
send an application key response to the application function with the AKMA application key; and
when the access type stored in the AKMA context does not comprise an authorized type of access:
send the application key response to the application function with an error code.

18. User equipment that supports Authentication and Key Management for Applications (AKMA), the user equipment comprising:
at least one processor; and
at least one memory storing instructions that, when executed by the at least one processor, cause the user equipment at least to:
receive an AKMA service indicator from a home public land mobile network of the user equipment, wherein the AKMA service indicator indicates whether an AKMA service is enabled or disabled for a registration of the user equipment with a serving network; and
perform derivation of an AKMA anchor key when the AKMA service indicator indicates that the AKMA service is enabled.
